(19) United States
(12) Patent Application Publication
(10) Pub. No.: US 2024/0232956 A9
(43) Pub. Date: Jul. 11, 2024

(54) METHOD FOR MONETIZING DATA FOR A RELIGIOUS ORGANIZATION

(71) Applicant: Data Vault Holdings, Inc., New York, NY (US)

(72) Inventors: Alfred Blair Blaikie, III, Tinton Falls, NJ (US); Nathaniel T. Bradley, Tucson, AZ (US); Joshua S. Paugh, Tucson, AZ (US)

(73) Assignee: Data Vault Holdings, Inc., New York, NY (US)

(21) Appl. No.: 18/491,119

(22) Filed: Oct. 20, 2023

Related U.S. Application Data
(60) Provisional application No. 63/380,348, filed on Oct. 20, 2022.

(51) Int. Cl. G06Q 30/0279; G06F 3/0484; G06Q 20/12; G06Q 40/04; G06Q 40/06; H04L 9/32

(52) U.S. Cl. CPC G06Q 30/0279; G06F 3/0484; G06Q 20/1235; G06Q 40/04; G06Q 40/06; H04L 9/3213

(57) ABSTRACT

Embodiments of the present disclosure may include a method for monetizing data for a religious organization, including receiving a selection from a user to monetize data associated with a data object for benefit of a religious organization. Embodiments may also include compiling the data associated with the data object. Embodiments may also include generating a security token including a reference to the data object. Embodiments may also include monetizing the data object utilizing the security token in accordance with the selection. In some embodiments, the data associated with the data object includes data independently obtained from the religious organization associated with the user.

### RELATED APPLICATIONS

This application claims priority to U.S. Provisional Patent Application No. 63/380,348, filed on Oct. 20, 2022 and entitled “METHOD FOR MONETIZING DATA FOR A RELIGIOUS ORGANIZATION”, hereby incorporated by reference in its entirety.

### BACKGROUND

### I. Field of the Disclosure

The illustrative embodiments relate to data management, valuation and monetization systems. More specifically, but not exclusively, the illustrative embodiments relate to a system, method, apparatus, and platform for the valuation, management, and utilization of objectified data objects associated with religious services and organizations.

### II. Description of the Art

In recent years, data security, cyber-attacks and big data breaches have led to the development of technology initiatives to secure data and make it available for users, including blockchain, cryptocurrencies, fire walls, and security and encryption technologies. These technologies have largely fallen short of protecting or properly capturing all the available consumer data. The commercial Internet is still largely dependent on digital advertisement revenue derived from user or personal data that is typically monetized through advertising and resulting consumer or commercial product sales. User data is being captured, searched and used in targeted ad revenue production and delivery by the big data companies. Search engines, web destinations, and physical real-world sources of data are abundant and grossly underserved in the fields of capture, valuation, and monetization. Big data companies collect, analyze, verify and sell consumer data across all known web environments. The data is monetized by collecting and tracking interactions across an array of platforms, sites, devices, questionnaires, surveys and so forth.

Often, the current mechanisms fall short in the ability to price the resulting data and do not provide accurate data capture or network or exchanges for data purchasing, development, and transaction. Consumers' online profile data is commonly generated and monetized from consumer web searches, profile data, social media profiles, and online surveys that generate revenue through advertisement delivery with no compensation to the actual owners of the data, the individual consumers/users, consumer groups, organizations, and data generators themselves.

A set of seemingly unrelated problems to one not having the benefit of this disclosure relates to problems facing religious services and religious organizations. In a technology-driven world, religious services and organizations may struggle to engage with members in meaningful ways. This problem was further exacerbated during the pandemic when in-person religious services may have been cancelled or individuals may have limited attendance. This lack of engagement has limited traditional fundraising for religious organizations and limited charitable contributions.

What is needed are technological solutions for religious organizations which help facilitate engagement with members and enhance fundraising efforts.

### BRIEF SUMMARY

Therefore, it is a primary object, feature, or advantage to improve over the state of the art.

It is a further object, feature, or advantage to provide for data management for managing data of religious organizations.

It is a still further object, feature, or advantage to provide for data valuation for religious organizations.

It is another object, feature, or advantage to provide for monetization of data for religious organizations.

A further object, feature, or advantage is to increase or enhance technology-driven engagement of members of religious organizations.

A still further object, feature, or advantage is to enhance fund-raising of religious organizations.

One more of these and/or other objects, features, or advantages will become apparent from the specification and claims that follow. No single embodiment needs to meet or exhibit each and every object, feature, or advantage. Different embodiments may have different objects, features, or advantages.

Embodiments of the present disclosure may include a method for monetizing data for a religious organization, including receiving a selection from a user to monetize data associated with a data object for benefit of a religious organization. Embodiments may also include compiling the data associated with the data object. Embodiments may also include generating a security token including a reference to the data object. Embodiments may also include monetizing the data object utilizing the security token in accordance with the selection. In some embodiments, the data associated with the data object includes data independently obtained from the religious organization associated with the user.

In some embodiments, the security token may be a blockchain-based token utilized by a blockchain platform. In some embodiments, the data object includes one or more profiles associated with the user, a website, an application, or a service. In some embodiments, at least one of the one or more profiles includes the data independently obtained from the religious organization associated with the user.

In some embodiments, the method may include storing the data object in a secure storage associated with the religious organization. Embodiments may also include creating access information to the data object referenced in the security token. In some embodiments, the method may include electronically sending a receipt to the user for contribution of the data associated with the data object.

In some embodiments, the data independently obtained from the religious organization associated with the user may include membership data for the user within the religious organization. In some embodiments, the membership data may include at least one of religious service attendance data and religious organization charitable contribution data for the individual.

In some embodiments, the data independently obtained from the religious organization associated with the user may include engagement data on one or more digital platforms of the religious organization. In some embodiments, the method may include trading the security token on a data exchange in exchange for monetary value.

Embodiments of the present disclosure may also include a method for managing assets of a religious organization, including maintaining a registry of data backed assets of the religious organization. Embodiments may also include providing an interface to access the registry of data backed assets of the religious organization. In some embodiments, entries within the registry of data backed assets includes entries for assets having real estate value, entries corresponding to programmatically defined smart contracts having non-fungible token (NFT) value, and entries having hard asset value.

In some embodiments, the religious organization may be a hierarchical organization including a plurality of subunits. In some embodiments, the interface may be configured to display the data backed assets associated with each of the plurality of subunits. In some embodiments, the entries corresponding to the programmatically defined smart contracts having non-fungible token (NFT) value include security tokens including a reference to a data object including data about a member of the religious organization for which the religious organization has a right to monetize under the smart contracts.

In some embodiments, the data about the member of the religious organization includes data obtained from the religious organization about the member. In some embodiments, the data obtained from the religious organization about the user may include membership data for the user within the religious organization. In some embodiments, the data obtained from the religious organization associated with the user may include engagement data on one or more digital platforms of the religious organization. In some embodiments, the hard asset value includes works of art.

In some embodiments, the membership data may include at least one of religious service attendance data and religious organization charitable contribution data for the member.

Embodiments of the present disclosure may also include a monetization platform for religious organizations including a user interface for recording audio or video of a content creator. Embodiments may also include a plurality of computer systems connected via a network, where the plurality of computer systems, form at least one immutable ledger. Embodiments may also include provide a non-fungible token (NFT) registry, where entries in the NFT registry correspond to programmatically defined smart contracts written to the at least one immutable ledger.

In some embodiments, at least one of the computer systems may be configured as an NFT registry service, where the NFT registry service may be capable of authenticating a representative of the religious organization based in part on input received from the representative of the religious organization through the user interface. Embodiments may also include minting NFTs to the at least one immutable ledger and recording the minted NFT in the NFT registry, where minted NFTs may be cryptographically co-signed by the NFT registry service and an authenticated representative of the religious organization. In some embodiments, the user interface may be configured to display text of at least one of a prayer, a religious song, and a verse of scripture to the content creator during the recording of the audio or the video.

Embodiments of the present disclosure may also include a user device, including a processor. Embodiments may also include a network interface. Embodiments may also include memory containing a software application including a media wallet component. In some embodiments, the processor may be capable of being configured by the media wallet application to securely store non-fungible tokens (NFTs), where each NFT may be associated with a programmatically defined smart contract written to at least one immutable ledger. Embodiments may also include perform transactions for at least one of buying and selling one or more NFT. Embodiments may also include provide a media viewer for accessing content associated with the NFTs. Embodiments may also include providing a user interface for requesting an NFT from a religious organization.

In some embodiments, the interface for requesting the NFT from the religious organization provides for requesting a specific prayer. In some embodiments, the interface for requesting the NFT from the religious organization further provides for requesting the specific prayer be performed by a specific individual or a specific group. In some embodiments, the software application may include a data monetization component configured to receive a selection from a user to monetize data associated with a data object for benefit of a religious organization, the data object containing data associated with the user and to donate monetization of the data to the religious organization.

### BRIEF DESCRIPTION OF THE FIGURES

FIG. 1 is a flowchart illustrating a method for monetizing data for a religious organization, according to some embodiments of the present disclosure.

FIG. 2 is a flowchart further illustrating the method for monetizing data for a religious organization from FIG. 1, according to some embodiments of the present disclosure.

FIG. 3 is a flowchart further illustrating the method for monetizing data for a religious organization from FIG. 1, according to some embodiments of the present disclosure.

FIG. 4 is a flowchart illustrating a method for managing assets of a religious organization, according to some embodiments of the present disclosure.

FIG. 5 is a block diagram illustrating a monetization platform, according to some embodiments of the present disclosure.

FIG. 6 is a block diagram illustrating a user device, according to some embodiments of the present disclosure.

FIG. 7 is a block diagram further illustrating the user device from FIG. 6, according to some embodiments of the present disclosure.

FIG. 8 is a block diagram of a data management system which may serve as a central repository of data from disparate data sources.

FIG. 9 is a flow chart of one example of a method which may be used to create a NFT associated with a prayer or performance.

FIG. 10 includes a screen display which may be displayed on a display associated with a computing device.

FIG. 11 illustrates one example of a screen display from a software application which may be a mobile app which is used for engagement between a religious organization and its members.

FIG. 12 is a block diagram of a platform for monetizing religious data.

### DETAILED DESCRIPTION

Various aspects associated with a religious organization's use of data management, valuation, and monetization systems are shown and described herein. Although different embodiments are shown and described, it is to be understood that various embodiments may be combined.

The illustrative embodiments provide a system, method, and platform for tokenizing content for spiritual organizations, Churches, non-profits, and/or religious groups. Content whether real, virtual, or idea-based may be captured in non-fungible tokens, a dedicated cryptocurrency, and/or blockchain tokens. The organization may utilize the tokenized content for charitable contributions, specific projects (e.g., building, water wells, clothing donations, disaster relief, etc.), or other needs. The tokens may also be exchanged for service hours, prayers, in-kind contributions, scripture reading, good works, attendance at services/events, and so forth. One or more exchanges may also be utilized to create value and a market for the tokens. The illustrative embodiments may combine the best practices and outcomes of religious organizations, blockchain, and virtual and augmented reality (e.g., metaverse, virtual platforms, etc.). The additional methods of reaching parishioners, members, and other individuals and fundraising, receiving, donations, or enhancing experiences are very important to various types of organizations.

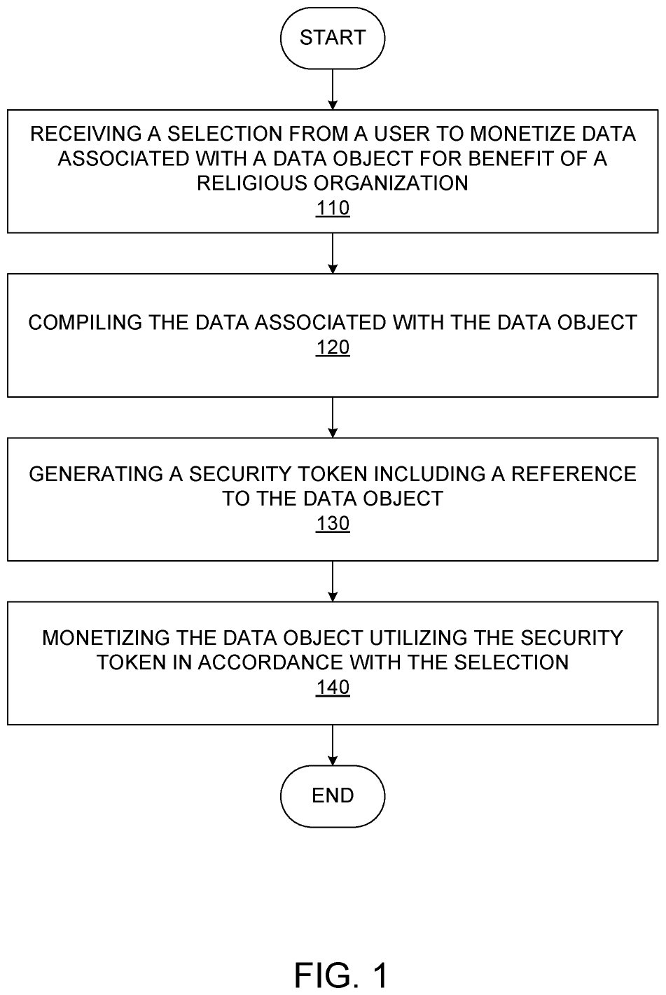

FIG. 1 is a flowchart that describes a method for monetizing data for a religious organization, according to some embodiments of the present disclosure. In some embodiments, at 110, the method may include receiving a selection from a user to monetize data associated with a data object for benefit of a religious organization. This selection for a user may be received in various ways. For example, this selection may be received through a user interface of a software application, on a web site, through a mobile app, or otherwise. In some embodiments, a religious organization may send a text message or email to the user with a link which the user can follow to make this selection. In some embodiments, there may be intermediate steps such as sending the user a link to a software application which the user installs and then makes a selection to monetize data associated with the user. The data object may include data about the user and the online activity, web site visits, online purchasing activity, social media activity, or other data about the user which may be of value to advertisers and online advertisers. The selecting allows for the user to confirm their intent to share this data for the benefit of the religious organization. In some embodiments, the user may select a subset of available data to share for the benefit of the religious organization. In some embodiments, the user may select a time period during which their data may be used. In some embodiments, the user may select to periodically renew or update the data.

At 120, the method may include compiling the data associated with the data object. This may include the various types of data previously discussed. In some embodiments, additional data from the religious organization may be included. This may include membership data, attendance data, charitable giving data (e.g., present, historical, etc.), or other data which is independently collected by the religious organization.

At 130, the method may include generating a security token including a reference to the data object. Thus, the data object is now tokenized. This is advantageous in various ways including for security where the data object is encrypted. The resulting security token is portable and tradeable.

At 140, the method may include monetizing the data object utilizing the security token in accordance with the selection. As previously discussed, the data associated with the data object may include data independently obtained from the religious organization associated with the user as well as from the user. Access to this data may be purchased through an exchange or otherwise and may be used according to any applicable limitations set forth in smart contracts associated with the token, policies of the exchange, or otherwise created.

In some embodiments, the security token may be a blockchain-based token utilized by a blockchain platform. In some embodiments, the data object may include one or more profiles associated with the user, a website, an application, or a service. At least one of the one or more profiles may include the data independently obtained from the religious organization associated with the user. In some embodiments, the data independently obtained from the religious organization associated with the user includes engagement data on one or more digital platforms of the religious organization. In some embodiments, the method may include trading the security token on a data exchange in exchange for monetary value.

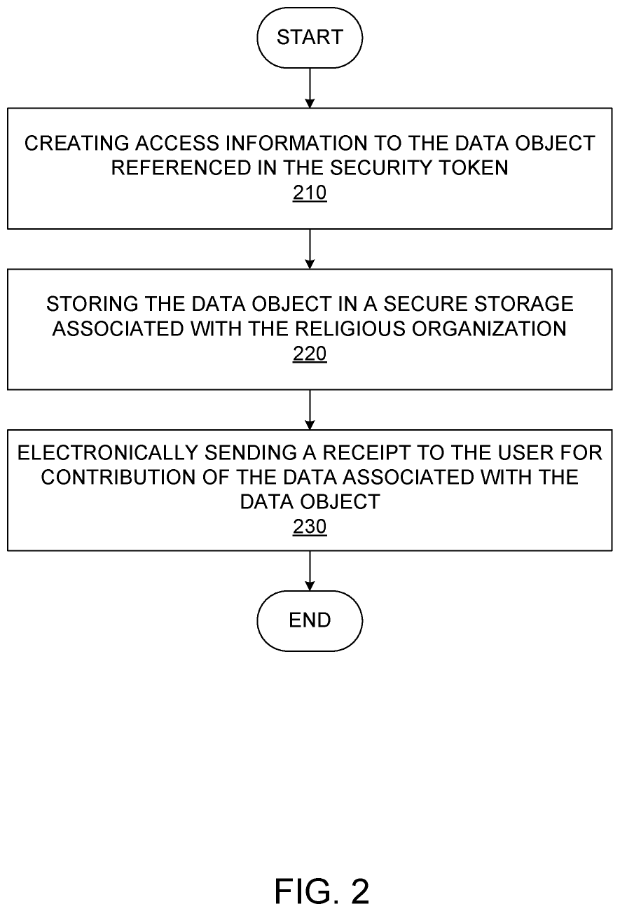

FIG. 2 is a flowchart that further describes the method for monetizing data for a religious organization from FIG. 1, according to some embodiments of the present disclosure. In some embodiments, at 210, the method may include creating access information to the data object referenced in the security token. A secured link or access information may be utilized to create a secure access to the information associated with the security token. At 220, the method may include storing the data object in a secure storage associated with the religious organization. Alternatively, the data may be stored elsewhere. In some embodiments, at 230, the method may include electronically sending a receipt to the user for contribution of the data associated with the data object. For example, in some embodiments, upon creation of the token, a receipt may be sent to the user so as to confirm their contribution of the data for the benefit of the religious organization. The receipt may be sent by email, text message, chat, or other type of message or otherwise. Where the functionality described is integrated into a web site or mobile app, the user may also receive a notification through the web site or mobile app regarding the receipt.

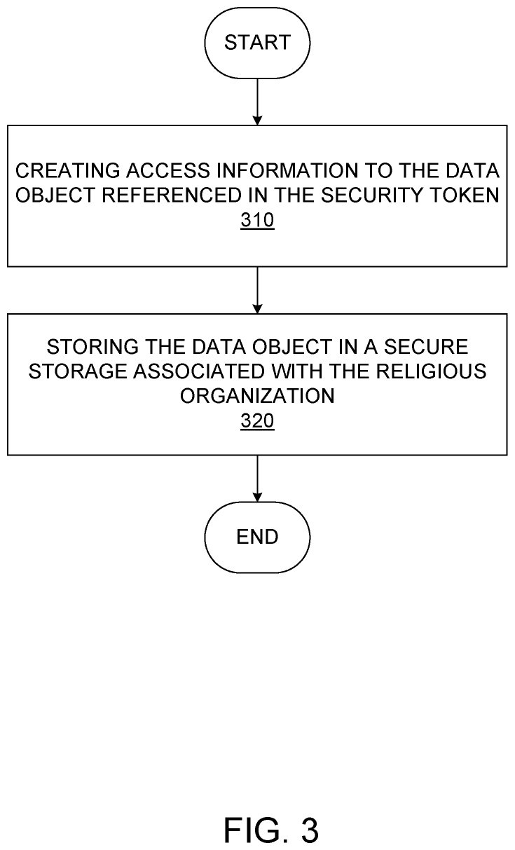

FIG. 3 is a flowchart that further describes the method for monetizing data for a religious organization from FIG. 1, according to some embodiments of the present disclosure. In some embodiments, at 310, the storing may include creating access information to the data object referenced in the security token. At 320, the method may include storing the data object in a secure storage associated with the religious organization. In some embodiments, the data independently obtained from the religious organization associated with the user may comprise membership data for the user within the religious organization. In some embodiments, the membership data comprises at least one of religious service attendance data and religious organization charitable contribution data for the individual.

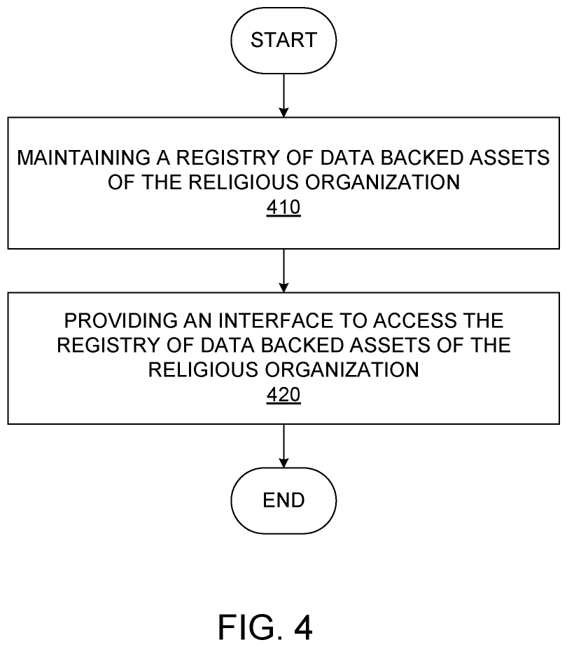

FIG. 4 is a flowchart that describes a method for managing assets of a religious organization, according to some embodiments of the present disclosure. In some embodiments, a religious organization may manage a collection of different assets including digital assets and including data assets. In some embodiments, at 410, the method may include maintaining a registry of data backed assets of the religious organization. At 420, the method may include providing an interface to access the registry of data backed assets of the religious organization. Entries within the registry of data backed assets may include entries for assets having real estate value, entries corresponding to programmatically defined smart contracts having non-fungible token (NFT) value, and entries having hard asset value.

In some embodiments, the religious organization may be a hierarchical organization comprising a plurality of subunits. The interface may be configured to display the data backed assets associated with each of the plurality of subunits. In some embodiments, the entries corresponding to the programmatically defined smart contracts having non-fungible token (NFT) value may include security tokens including a reference to a data object comprising data about a member of the religious organization for which the religious organization may have a right to monetize under the smart contracts.

In some embodiments, the data about the member of the religious organization may include data obtained from the religious organization about the member. The data obtained from the religious organization about the user may comprise membership data for the user within the religious organization. In some embodiments, the data obtained from the religious organization associated with the user comprises engagement data on one or more digital platforms of the religious organization. In some embodiments, the hard asset value may include works of art.

In some embodiments, the membership data comprises at least one of religious service attendance data and religious organization charitable contribution data for the member.

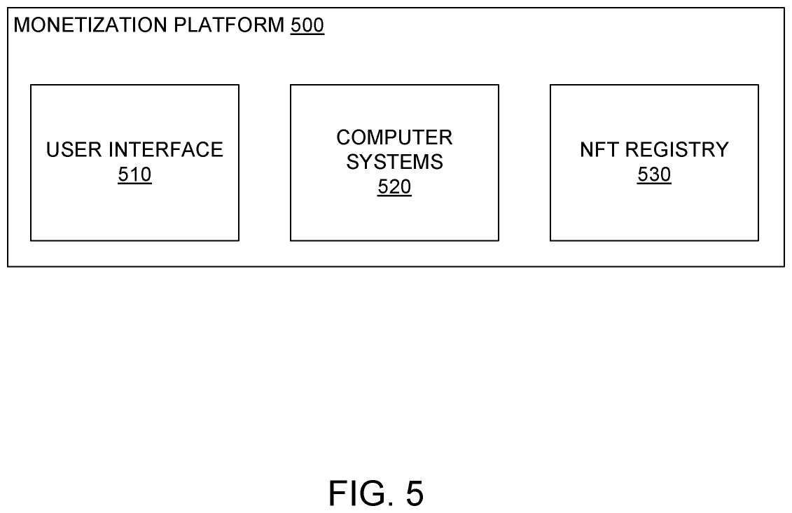

FIG. 5 is a block diagram that describes a monetization platform 500, according to some embodiments of the present disclosure. In some embodiments, the monetization platform 500 may include a user interface 510 for recording audio or video of a content creator to at least one immutable ledger. The monetization platform 500 may also include a plurality of computer systems 520 connected via a network, where the plurality of computer systems 520 provide a non-fungible token (NFT) registry 530, where entries in the NFT registry correspond to programmatically defined smart contracts written to the at least one immutable ledger.

In some embodiments, at least one of the computer systems 520 may be configured as an NFT registry service, where the NFT registry service may be capable of authenticating a representative of the religious organization based in part on input received from the representative of the religious organization through the user interface 510. At least one of the computer systems may be configured for minting NFTs to the at least one immutable ledger and recording the minted NFT in the NFT registry, where minted NFTs may be cryptographically co-signed by the NFT registry service and an authenticated representative of the religious organization. In some embodiments, the user interface 510 may be configured to display text of at least one of a prayer, a religious song, and a verse of scripture to the content creator during the recording of the audio or the video which is data associated with the NFT.

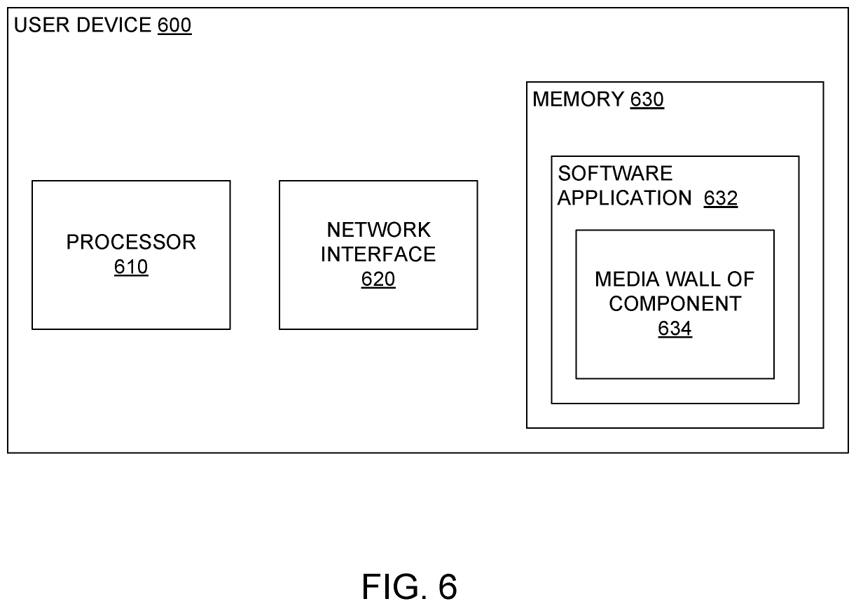

FIG. 6 is a block diagram that describes a user device 600, according to some embodiments of the present disclosure. In some embodiments, the user device 600 may include a processor 610, a network interface 620, and memory 630. The memory 630 may include a software application 632 which may include a set of instructions to perform various steps and functionality described herein which may be stored in memory 630 and executing on the processor 610. The software application 632 may include a media wallet component 634. The processor 610 may be capable of being configured by the media wallet application to securely store non-fungible tokens (NFTs), where each NFT may be associated with a programmatically defined smart contract written to at least one immutable ledger. The media wallet application may be further configured to perform transactions for at least one of buying and selling one or more NFTs. The media wallet application may further provide a media viewer for accessing content associated with the NFTs. The media wallet application may further provide a user interface for requesting an NFT from a religious organization. In some embodiments, the interface for requesting the NFT from the religious organization may provide for requesting a specific prayer. In some embodiments, the interface for requesting the NFT from the religious organization may further provide for requesting the specific prayer be performed by a specific individual or a specific group. The request may be for a prayer, blessing, song, hymn, scripture reading, or other performance. In some embodiments, the request may be for a particular individual, family, group, and/or a specific situation and may include desired relief or a desired result to be obtained.

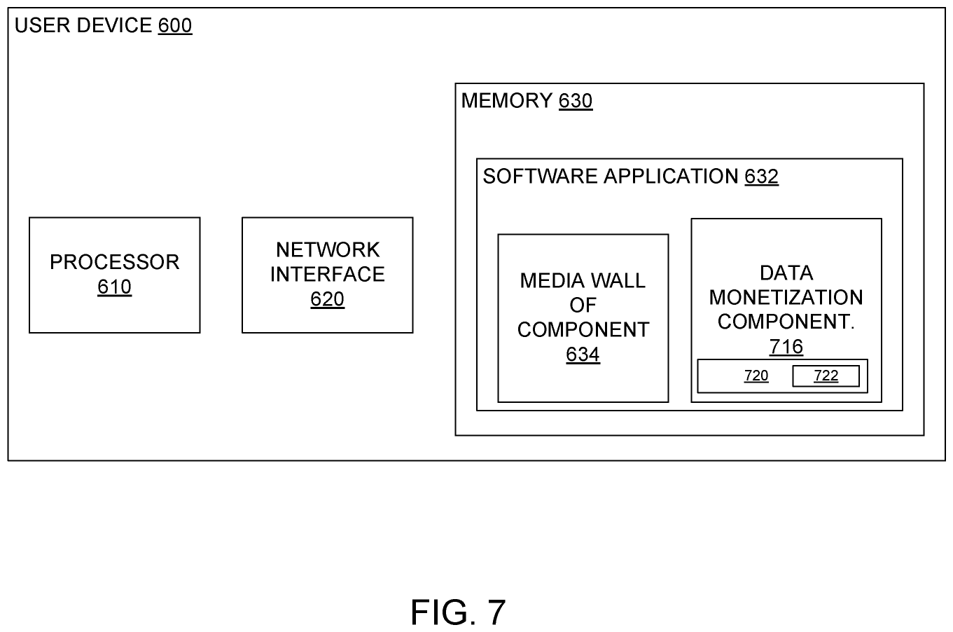

FIG. 7 is a block diagram that further describes the user device 600 from FIG. 6, according to some embodiments of the present disclosure. In some embodiments, the software application 632 may include a data monetization component 716 configured to receive a selection from a user to monetize data associated with a data object 720 for benefit of a religious organization. The data object 720 may include data 722 associated with the user and to donate monetization of the data 722 to the religious organization. This data monetization has been previously described. It is to be understood, however, that the same software application used by an individual to monetize their data for the benefit of the religious organization may also be used to store NFTs, to make requests for NFTs. In some embodiments, the software application 632 may provide additional engagement with the religious organization such as by streaming religious services, collecting charitable contributions, distributing religious organization news, signing up for events of the religious organization, displaying a directory for the religious organization or subunits of the religious organization, or otherwise providing features, functionality of benefit to the religious organization and individuals associated with the religious organization.

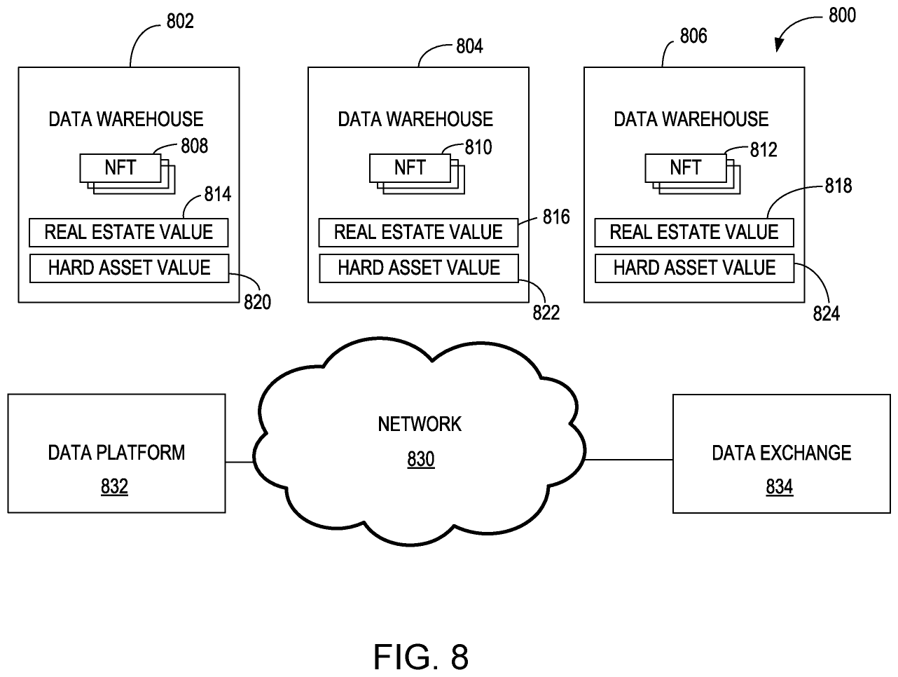

FIG. 8 is a block diagram of a system 800. As shown, there are a plurality of data warehouses 802, 804, 806. Each of the data warehouses is a data management system which may serve as a central repository of data from disparate data sources. As shown here, each of the data warehouses 802, 804, 806 may be for a different religious organization. Each of the data warehouses may be used to store data assets associated with the religious organization or subunits of the religious organization such as individual churches or parishes or regional groupings of individual churches. The data assets stored may include NFTs 808, 810, 812, real estate value 814, 816, 818, and/or hard asset value 820, 822, 824. Each of the data warehouses 802, 804, 806 may be operatively connected to a network 830. A data platform 832 and a data exchange 834 may also be operatively connected to the network 830.

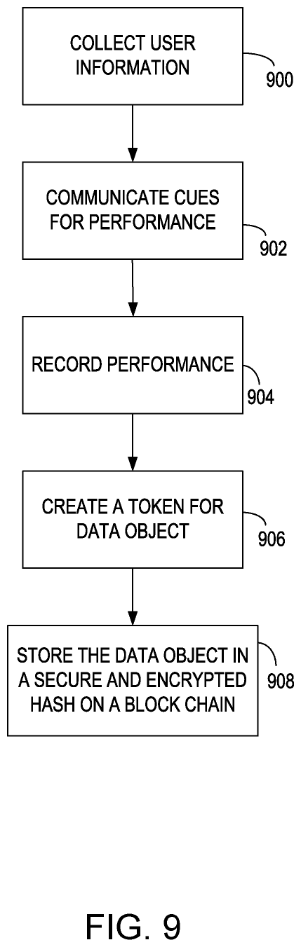

FIG. 9 is a flow chart of one example of a method which may be used to create a NFT associated with a prayer or performance. The method shown in FIG. 9 may be implemented using one or more computing devices. In some embodiments, portions of the method may be implemented using a mobile device such as a cell phone or tablet computer while other portions of the method may be implemented using a server or service accessible to the mobile device over a network. For example, in step 900 user information is collected. The user information may be collected using a mobile device executing a web browser or through a software application such as a mobile application executing on one or more processors of the mobile device. Next in step 902, cues for a performance may be communicated to a user such as by displaying the cues to a user. In some embodiments, the cues may be in the form of words displayed on a display. For example, where an NFT which includes an audio or video performance of a prayer, the cue may include the words to the prayer. Where the audio or video performance is of a reading of one or more verses of scripture, the cue may include the text of the one or more verses of scripture. If the audio or video performance is of a song or hymn then the cue may include the words of the song or hymn and/or a musical score. Where the NFT is personalized such as for a specific person, then the cue may include personalized information such as the name of the person, the situation to pray for, or other information. In some embodiments the cues may be presented as visual cues. In other embodiments the cues may include audio cues or a combination of audio and visual cues.

The inclusion of the cues is an advantage in that they facilitate the performance of the audio or video recording to be associated with an NFT in a timely and efficient manner to eliminate or reduce the need for multiple attempts at audio or video recording, help facilitate personalization, and to assist in providing genuine and authentic performances. In step 904, the performance is recorded. It should be understood that cues may be communicated before and/or during the performance. The resulting video, audio, or images which are recorded may be included in a data object for which a token is created in step 906. This step may be performed using a NFT registry service. In step 908, the data object or a reference to the data object may be stored in a secure and encrypted hash on a block chain.

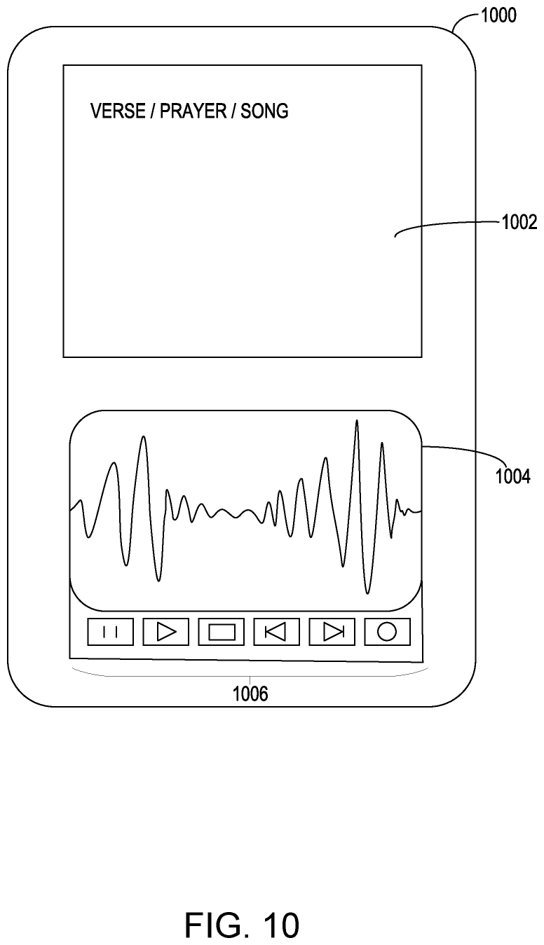

FIG. 10 includes a screen display 1000 which may be displayed on a display associated with a computing device. For example, the screen display 1000 may be displayed on a mobile device. The user interface associated with the screen display 1000 may include a cue display area 1002. The cue display area 1002 may show the words to a verse, a prayer, a song, or may include text information about an individual, group, or situation for which prayers are requested. A media recording area 1004 is also shown which may provide an interface and controls 1006 for audio recording and/or video recording and/or playback (e.g., record, stop, play, fast forward, rewind, etc.). The screen display 1000 may also allow for additional information to be collected about the content creator such as their name, title, religious organization affiliation. Where the recording is made as a request from another, such as a prayer request, the screen display 1000 may include user interface elements showing who made the prayer request, when the request was made, the reason for the request, or other information about the recording.

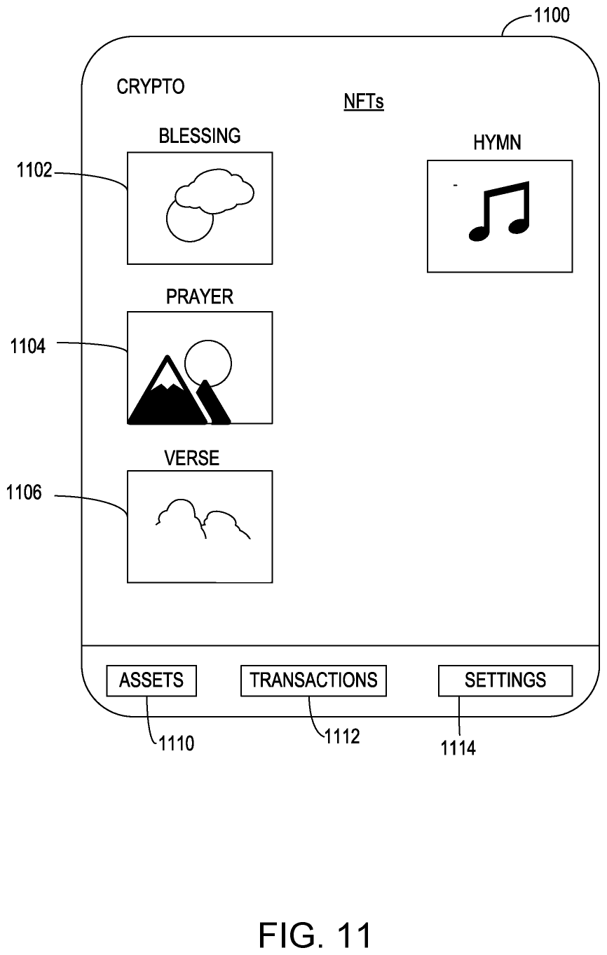

FIG. 11 illustrates one example of a screen display 1100 from a software application which may be a mobile app which is used for engagement between a religious organization and its members. One component of the software application may allow for the user to show and access different NFTs generated by the religious organization or obtained directly or indirectly from the religious organization. This may include NFTs 1102, 1104, 1106 which may include blessings, prayers, readings of verses of scripture, singing of hymns, or other religious messages. The NFTs may have been purchased by the user or gifted to the user. The screen display 1100 may also include controls, selectors, or buttons for adding, managing, or modifying assets 1110, transactions 1112, and settings 1114 associated with the religious organization and NFTs 1102, 1104, 1106.

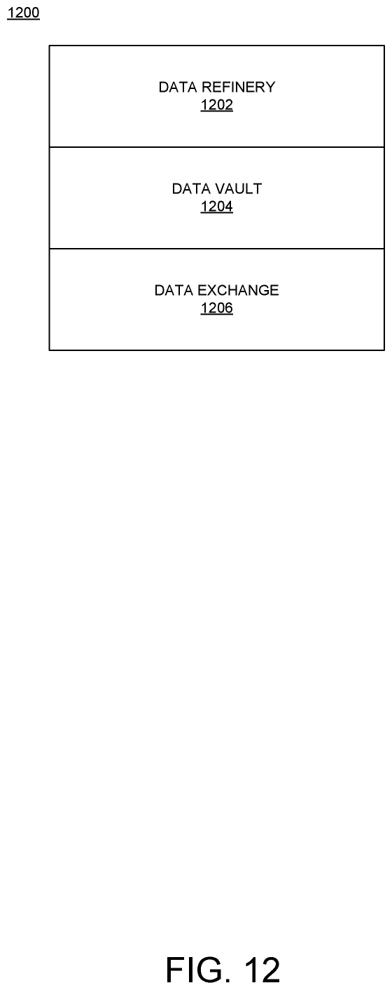

FIG. 12 is a block diagram of a platform 1200 for monetizing religious data. The platform 1200 may include a data refinery 1202, a data vault 1204, and a data exchange 1206. The platform 1200 of FIG. 12 may be representative of one or more devices, such as the system, servers, or platform of FIG. 8 or the other Figures as well as the other smart networked device implementing specific hardware, software, firmware, and/or sets of instructions. The platform 1200 including the data refinery 1202, data vault 1204, and the data exchange 1206 may function as separate platforms or an integrated platform.

The data refinery 1202 is utilized to create data objects and capture applicable data to include the data objects as described herein. In one embodiment, the data refinery 1202 may be positioned within the user's existing system to capture data that is already received, entered, gleaned, or otherwise determined by the existing system (e.g., software or systems utilized by a Church or religious organization). The data object may be created to store all, portions, or types of data associated with the user (e.g., Church, charity, religious group, individual, couple, family, company, organization, entity, etc.).

The data vault 1204 is utilized to securely store the data objects and add, modify, and improve the associated data. In one embodiment, the data vault may be utilized to collect, characterize, and value the data. The data vault 1204 may also determine the pace at which new data objects are added or updated as well as the types of data. For example, the data vault 1204 may determine that information relevant to two of the user's clients including company preferences for wireless services and legal services are added to the data vault 1204 each day. The data vault 1204 may be a physical or virtual storage and vault that securely stores information. In one embodiment, the data objects may be deidentified to remove identifying information to prevent hacking, identity theft, and other unwanted or prohibited utilization of data. The data vault 1204 may also assign an initial value for the data object. The value may be associated with similar data, going rates, completeness of the data, the type of data, the user supplying the data, historical information, and so forth. The value may change at any time based on a determination of the platform 1204 (i.e., the data vault or data exchange).

The data exchange 1206 is utilized to price and perform transactions for the data objects. In one embodiment, the data exchange 1206 creates a ticker associated with the data object. The ticker may be associated with the data object(s) for a user. The data exchange 1206 allows the data objects to be priced and purchased. In one embodiment, the exchange may utilize secure tokens to access the data. For example, transactions involving the data may represent a key for accessing the purchased or leased data. For example, the tokens may include an encryption key, password, biometric, or other secure identifier for accessing the data object from the data vault or other stored location.

In some embodiments, the religious organization may have its own cryptocurrency. Where the religious organization has its own cryptocurrency, it may require NFTs to be purchased using its cryptocurrency.

The illustrative embodiments, allow for individuals, groups, or congregations to collectively give as a way to support churches and religious organizations through immediate or passive revenue. For example, a specific prayer token may be generated and minted for an individual, family, purpose, and/or cause that is accompanied by a smart contract for associating donations with the token individual, family, and/or cause. Tokens may be minted for individual contributions or based on groups of contributions with a specified purpose or cause. Money may be sent directly and exclusively to the individual/group/church/cause or portions of the contributions may be shared with the church or other associated parties. The unique data tokenization process may be employed across various different types of congregations, groups, parishioners, participants, or members. The various individuals may elect to share tokenized components of their data profile(s) with advertisers as a passive contribution to the church. Individuals that elect to participate in the data sharing process may be connected with likeminded advertisers, companies, brands, and charities that support causes that are representative of the values of the church or that are approved and authorized partners.

Therefore, various, methods, apparatuses, and systems have been shown and described. Although specific examples have been shown and described, numerous options, variations, and alternatives are contemplated. For example, where specific user interfaces are shown, it is to be understood that these user interfaces may be modified to display or collect additional information through any number of additional user interface components. In addition, user interfaces need not be visual in nature, but may be based on audio input or other types of input, or multi-modal input.

The methods described herein or aspects thereof may be incorporated into software in the form of instructions stored on a non-transitory computer or machine readable medium.

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

Certain embodiments may be described herein as implementing mathematical methodologies including logic or a number of components, modules, or mechanisms. Modules may constitute either software modules (e.g., code embodied on a machine-readable medium or in a transmission signal) or hardware modules. A hardware module is tangible unit capable of performing certain operations and may be configured or arranged in a certain manner. In example embodiments, one or more computer systems (e.g., a standalone, client or server computer system) or one or more hardware modules of a computer system (e.g., a processor or a group of processors) may be configured by software (e.g., an application or application portion) as a hardware module that operates to perform certain operations as described herein.

In various embodiments, a hardware module may be implemented mechanically or electronically. For example, a hardware module may comprise dedicated circuitry or logic that is permanently configured (e.g., as a special-purpose processor, such as a field programmable gate array (FPGA) or an application-specific integrated circuit (ASIC)) to perform certain operations. A hardware module may also comprise programmable logic or circuitry (e.g., as encompassed within a general-purpose processor or other programmable processor) that is temporarily configured by software to perform certain operations. It will be appreciated that the decision to implement a hardware module mechanically, in dedicated and permanently configured circuitry, or in temporarily configured circuitry (e.g., configured by software) may be driven by cost and time considerations.

Accordingly, the term “hardware module” should be understood to encompass a tangible entity, be that an entity that is physically constructed, permanently configured (e.g., hardwired), or temporarily configured (e.g., programmed) to operate in a certain manner or to perform certain operations described herein. As used herein, “hardware-implemented module” refers to a hardware module. Considering embodiments in which hardware modules are temporarily configured (e.g., programmed), each of the hardware modules need not be configured or instantiated at any one instance in time. For example, where the hardware modules comprise a general-purpose processor configured using software, the general-purpose processor may be configured as respective different hardware modules at different times. Software may accordingly configure a processor, for example, to constitute a particular hardware module at one instance of time and to constitute a different hardware module at a different instance of time.

Hardware modules can provide information to, and receive information from, other hardware modules. Accordingly, the described hardware modules may be regarded as being communicatively coupled. Where multiple of such hardware modules exist contemporaneously, communications may be achieved through signal transmission (e.g., over appropriate circuits and buses) that connect the hardware modules. In embodiments in which multiple hardware modules are configured or instantiated at different times, communications between such hardware modules may be achieved, for example, through the storage and retrieval of information in memory structures to which the multiple hardware modules have access. For example, one hardware module may perform an operation and store the output of that operation in a memory device to which it is communicatively coupled. A further hardware module may then, at a later time, access the memory device to retrieve and process the stored output. Hardware modules may also initiate communications with input or output devices, and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules. Where the term “processor” is used, it is to be understood that it encompasses one or more processors whether located together or remote from one other.

Similarly, the methods described herein may be at least partially processor implemented. For example, at least some of the operations of a method may be performed by one or more processors or processor-implemented hardware modules. The performance of certain of the operations may be distributed among the one or more processors, not only residing within a single machine, but deployed across a number of machines. In some example embodiments, the processor or processors may be located in a single location, while in other embodiments the processors may be distributed across a number of locations.

The one or more processors may also operate to support performance of the relevant operations in a “cloud computing” environment or as a “software as a service” (SaaS). For example, at least some of the operations may be performed by a group of computers (as examples of machines including processors), these operations being accessible via a network (e.g., the Internet) and via one or more appropriate interfaces (e.g., application program interfaces (APIs).)

The performance of certain of the operations may be distributed among the one or more processors, not only residing within a single machine, but deployed across a number of machines. In some example embodiments, the one or more processors or processor-implemented modules may be located in a single geographic location. In other example embodiments, the one or more processors or processor-implemented modules may be distributed across a number of geographic locations.

Some portions of this specification are presented in terms of algorithms or symbolic representations of operations on data stored as bits or binary digital signals within a machine memory (e.g., a computer memory). These algorithms or symbolic representations are examples of techniques used by those of ordinary skill in the data processing arts to convey the substance of their work to others skilled in the art. As used herein, an “algorithm” is a self-consistent sequence of operations or similar processing leading to a desired result. In this context, algorithms and operations involve physical manipulation of physical quantities. Typically, but not necessarily, such quantities may take the form of electrical, magnetic, or optical signals capable of being stored, accessed, transferred, combined, compared, or otherwise manipulated by a machine. It is convenient at times, principally for reasons of common usage, to refer to such signals using words such as “data,” “content,” “bits,” “values,” “elements,” “symbols,” “characters,” “terms,” “numbers,” “numerals,” or the like. These words, however, are merely convenient labels and are to be associated with appropriate physical quantities.

Unless specifically stated otherwise, discussions herein using words such as “processing,” “computing,” “calculating,” “determining,” “presenting,” “displaying,” or the like may refer to actions or processes of a machine (e.g., a computer) that manipulates or transforms data represented as physical (e.g., electronic, magnetic, or optical) quantities within one or more memories (e.g., volatile memory, non-volatile memory, or a combination thereof), registers, or other machine components that receive, store, transmit, or display information.

As used herein any reference to “one embodiment” or “an embodiment” means that a particular element, feature, structure, or characteristic described in connection with the embodiment is included in at least one embodiment. The appearances of the phrase “in one embodiment” in various places in the specification are not necessarily all referring to the same embodiment.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present), and B is false (or not present), A is false (or not present), and B is true (or present), and both A and B are true (or present).

In addition, use of the “a” or “an” are employed to describe elements and components of the embodiments herein. This is done merely for convenience and to give a general sense of the disclosure. This description should be read to include one or at least one and the singular also includes the plural unless it is obvious that it is meant otherwise.

The terms “first,” “second,” “third,” “fourth,” and the like in the description and in the claims, if any, are used for distinguishing between similar elements and not necessarily for describing a particular sequential or chronological order. It is to be understood that the terms so used are interchangeable under appropriate circumstances such that the embodiments described herein are, for example, capable of operation in sequences other than those illustrated or otherwise described herein. Similarly, if a method is described herein as comprising a series of steps, the order of such steps as presented herein is not necessarily the only order in which such steps may be performed, and certain of the stated steps may possibly be omitted and/or certain other steps not described herein may possibly be added to the method.

As used herein, a plurality of items, structural elements, compositional elements, and/or materials may be presented in a common list for convenience. However, these lists should be construed as though each member of the list is individually identified as a separate and unique member. Thus, no individual member of such list should be construed as a de facto equivalent of any other member of the same list solely based on their presentation in a common group without indications to the contrary.

Reference throughout this specification to “an example” means that a particular feature, structure, or characteristic described in connection with the example is included in at least one embodiment. Thus, appearances of the phrases “in an example” in various places throughout this specification are not necessarily all referring to the same embodiment.

1. A method for monetizing data for a religious organization, comprising:
receiving a selection from a user to monetize data associated with a data object for benefit of a religious organization;
compiling the data associated with the data object;
generating a security token including a reference to the data object; and
monetizing the data object utilizing the security token in accordance with the selection;
wherein the data associated with the data object includes data independently obtained from the religious organization associated with the user.

2. The method of claim 1, wherein the security token is a blockchain-based token utilized by a blockchain platform.

3. The method of claim 1 wherein the data object includes one or more profiles associated with the user, a website, an application, or a service and wherein at least one of the one or more profiles includes the data independently obtained from the religious organization associated with the user.

4. The method of claim 1 further comprising storing the data object in a secure storage associated with the religious organization; and creating access information to the data object referenced in the security token.

5. The method of claim 4 further comprising electronically sending a receipt to the user for contribution of the data associated with the data object.

6. The method of claim 4 wherein the data independently obtained from the religious organization associated with the user comprises membership data for the user within the religious organization.

7. The method of claim 6 wherein the membership data comprises at least one of religious service attendance data and religious organization charitable contribution data for the individual.

8. The method of claim 1 wherein the data independently obtained from the religious organization associated with the user comprises engagement data on one or more digital platforms of the religious organization.

9. The method of claim 1 further comprising trading the security token on a data exchange in exchange for monetary value.

10. A method for managing assets of a religious organization, comprising:
maintaining a registry of data backed assets of the religious organization;
providing an interface to access the registry of data backed assets of the religious organization;
wherein entries within the registry of data backed assets includes entries for assets having real estate value, entries corresponding to programmatically defined smart contracts having non-fungible token (NFT) value, and entries having hard asset value.

11. The method of claim 10 wherein the religious organization is a hierarchical organization comprising a plurality of subunits and wherein the interface is configured to display the data backed assets associated with each of the plurality of subunits.

12. The method of claim 10 wherein the entries corresponding to the programmatically defined smart contracts having non-fungible token (NFT) value include security tokens including a reference to a data object comprising data about a member of the religious organization for which the religious organization has a right to monetize under the smart contracts.

13. The method of claim 12 wherein the data about the member of the religious organization includes data obtained from the religious organization about the member.

14. The method of claim 12 wherein the data obtained from the religious organization about the user comprises membership data for the user within the religious organization.

15. The method of claim 14 wherein the membership data comprises at least one of religious service attendance data and religious organization charitable contribution data for the member.

16. The method of claim 13 wherein the data obtained from the religious organization associated with the user comprises engagement data on one or more digital platforms of the religious organization.

17. The method of claim 10 wherein the hard asset value includes works of art.

18. A monetization platform for religious organizations comprising:
a user interface for recording audio or video of a content creator;
a plurality of computer systems connected via a network, where the plurality of computer systems:
form at least one immutable ledger; and
provide a non-fungible token (NFT) registry, where entries in the NFT registry correspond to programmatically defined smart contracts written to the at least one immutable ledger;
wherein at least one of the computer systems is configured as an NFT registry service, where the NFT registry service is capable of:
authenticating a representative of the religious organization based in part on input received from the representative of the religious organization through the user interface; and
minting NFTs to the at least one immutable ledger and recording the minted NFT in the NFT registry, where minted NFTs are cryptographically co-signed by the NFT registry service and an authenticated representative of the religious organization.

19. The monetization platform of claim 18 wherein the user interface is configured to display text of at least one of a prayer, a religious song, and a verse of scripture to the content creator during the recording of the audio or the video.

20. A user device, comprising:
a processor;
a network interface;
memory containing a software application comprising a media wallet component;
wherein the processor is capable of being configured by the media wallet application to:
securely store non-fungible tokens (NFTs), where each NFT is associated with a programmatically defined smart contract written to at least one immutable ledger,
perform transactions for at least one of buying and selling one or more NFT, and
provide a media viewer for accessing content associated with the NFTs;
providing a user interface for requesting an NFT from a religious organization.

21. The user device of claim 20 wherein the interface for requesting the NFT from the religious organization provides for requesting a specific prayer.

22. The user device of claim 21 wherein the interface for requesting the NFT from the religious organization further provides for requesting the specific prayer be performed by a specific individual or a specific group.

23. The user device of claim 20 wherein the software application further comprises a data monetization component configured to receive a selection from a user to monetize data associated with a data object for benefit of a religious organization, the data object containing data associated with the user and to donate monetization of the data to the religious organization.
